(19) United States
(12) Patent Application Publication
(10) Pub. No.: US 2010/0077030 A1
(43) Pub. Date: Mar. 25, 2010

(54) METHOD OF REPRESENTING SUBSCRIBE RELATION IN DESIGN PROCESS USING RELATIONS AMONG COMPONENTS

(75) Inventors: Sang Bong YOO, Bucheon-si (KR); Xun Li, Incheon (KR)

Correspondence Address: H.C. PARK & ASSOCIATES, PLC, 8500 LEESBURG PIKE, SUITE 7500, VIENNA, VA, 22182, US

(73) Assignee: INHA-INDUSTRY PARTNERSHIP INSTITUTE, Incheon (KR)

(21) Appl. No.: 12/391,012

(22) Filed: Feb. 23, 2009

(30) Foreign Application Priority Data
Sep. 22, 2008 (KR) 10-2008-0092812

(51) Int. Cl. G06F 15/16

(52) U.S. Cl. 709/204

(57) ABSTRACT

Provided is a method of representing a subscribe relation in a design process using a relation between components. The method includes establishing a resource description framework (RDF) site summary (or really simple syndication; RSS) subscribe relation between multiple design units dependent on each other in a design process using relation between product components, triggering, by the multiple design units, an event occurring in the design process of each component of a final product, to convert update information by the design modification event into an extended RSS subscribe format, and transmitting the extended RSS subscribe format to a corresponding design unit affected by the design modification.

### CROSS-REFERENCES TO RELATED APPLICATION

This patent application claims the benefit of priority under 35 U.S.C. § 119 from Korean Patent Application No. 10-2008-0082812 filed Sep. 22, 2008, the contents of which are incorporated herein by reference.

### BACKGROUND OF THE INVENTION

1. Field of the Invention

The present disclosure relates to a method of representing a subscribe relation in a design process using a relation between components.

2. Description of the Related Art

Generally, along with the expansion of the web 2.0 technology, general users as well as specific contents providers generate a large amount of information through blog, user created contents (UCC) and the like. A user may frequently require only the latest updated contents among the large amount of information. Against this backdrop, the RSS standards have emerged. The RSS standards, which is a publish/subscribe mechanism proposed by the World Wide Web Consortium (W3C), are designed to deliver a summary of the latest news or a new thread posted on a blog to a subscriber. Since the RSS is based on the eXtensible Markup Language (XML), the RSS has an excellent extensibility, and characteristics of an asynchrony, a many-to-many relation, and a loose linkage. While the initial design of the RSS was focused on the subscription of news and UCC on the Internet, attempts have recently been unrestrictedly conducted to meet requirements of, e.g., confirming the latest update in the corresponding field by including necessary tags to the typical RSS using the above-described characteristics of the RSS. For example, geographically encoded objects for RSS feeds (GeoRSS) may insert information such as position information and geography-related point, line and polygon information into the RSS in a self-defined tag format, to thereby deliver and represent geographical data update information between geography-related information software. In addition, a study conducted by Peter Murray-Rust et. al. allows chemical researchers to easily confirm updated information of the latest chemical research by combining the chemical markup language (CML) describing the chemical information with the RSS feed. In a concurrent engineering environment, various design units have a cooperative relation therebetween as a whole at the same time when designing each component of a product. In such a design process, the update process such as a structure modification and a spec modification may have effect on the other component designs related thereto. However, the update information is required to be delivered to only the designer of the corresponding component and other components related thereto. If the update information is delivered to an irrelevant designer to the corresponding component, an unnecessary traffic may occur due to the delivery of large amount of update information. Also, designers may be involved in filtering the update information to obtain information necessary to them, and the design contents may be unnecessarily exposed to a third party. The order subscription characteristics of the RSS may be a solution to the limitations caused by the indiscreet transmission of the update information, and facilitate representation and interpretation of a message based on the XML.

### SUMMARY OF THE INVENTION

Embodiments of the present invention are directed to provide a method of representing a subscribe relation in a design process using a relation between components, which defines a tag necessary for representing component information update in a cooperative design process, extends the tag to the RSS, and represents the product update information using the extended RSS in order to efficiently solve the limitations in the selective delivery and sharing of the design update information occurring in the concurrent engineering cooperative design process.

Embodiments of the present invention are also directed to provide a method of representing a subscribe relation in a design process using a relation between components, which allows only design units having the dependency relation therebetween to share the update information by representing and analyzing relation between components of the product using a resource description framework (RDF) to confirm the dependency relation between the component design units, and by establishing mutual subscribe relation of the extended RSS.

Embodiments of the present invention are also directed to provide a method of representing a subscribe relation in a design process using a relation between components, which maintains a conformity of subscribe relation of design update information by determining a new RSS subscribe relation and transmitting dependency relation update information to a design unit affected by a change of the relation between product components.

According to an aspect of the present invention, there is provided a method of representing a subscribe relation in a design process using a relation between components, the method comprising: establishing a RDF site summary (or really simple syndication; RSS) subscribe relation between multiple design units dependent on each other in a design process using relation between product components; triggering, by the multiple design units, an event occurring in the design process of each component of a final product, to convert update information by the design modification event into an extended RSS subscribe format; and transmitting the extended RSS subscribe format to a corresponding design unit affected by the design modification.

The triggering of the event may include: triggering the relation change between the components according to a change of the product structure to deliver the change-related relation information to a semantic-component relation module; checking the reasonableness of the semantic-component relation module; and converting the relation information into a component relation update information summary.

The event may be one of a component relation change, a design structure change, and a numerical value change.

The transmitting of the extended RSS subscribe format may include a concurrent engineering RSS (CE-RSS) tag.

The CE-RSS tag may include: an update information representation tag delivered to each design unit when the relation between product components changes; and an update information representation tag delivered to a corresponding component-related component design unit when there is a change in a component design process.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart illustrating a method of representing a subscribe relation in a design process using an interrelation between components according to an embodiment of the present invention;

FIG. 2 is a diagram illustrating a global management system (GMS), a structure of each design unit, and a data flow between the GMS and each design unit;

FIG. 3 is a diagram illustrating a work flow process in the GMS in FIG. 2;

FIG. 4 is a diagram illustrating a work flow process in the design unit in FIG. 2;

FIG. 5 is a diagram illustrating an interrelation between components of a design product according to an embodiment of the present invention; and

FIG. 6 is a diagram illustrating a RSS feed for determining a subscribe relation between design units using a CE-RSS tag transmitted from a GMS to the design unit according to an embodiment of the present invention.

### DESCRIPTION OF THE PREFERRED EMBODIMENTS

Hereinafter, embodiments of the present invention will be described in detail with reference to the accompanying drawings. While the accompanying drawings are provided to more clearly describe the features of the present invention, it will be understood by those skill in the art that the scope of the present invention should not be construed as limited to those of the accompanying drawings.

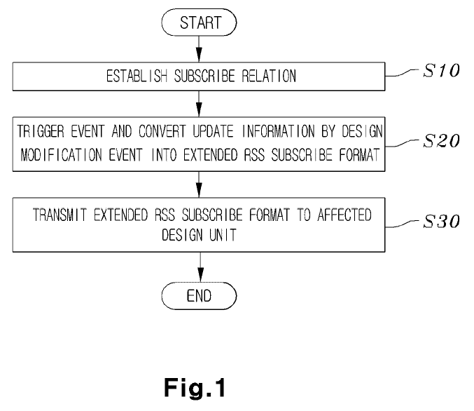

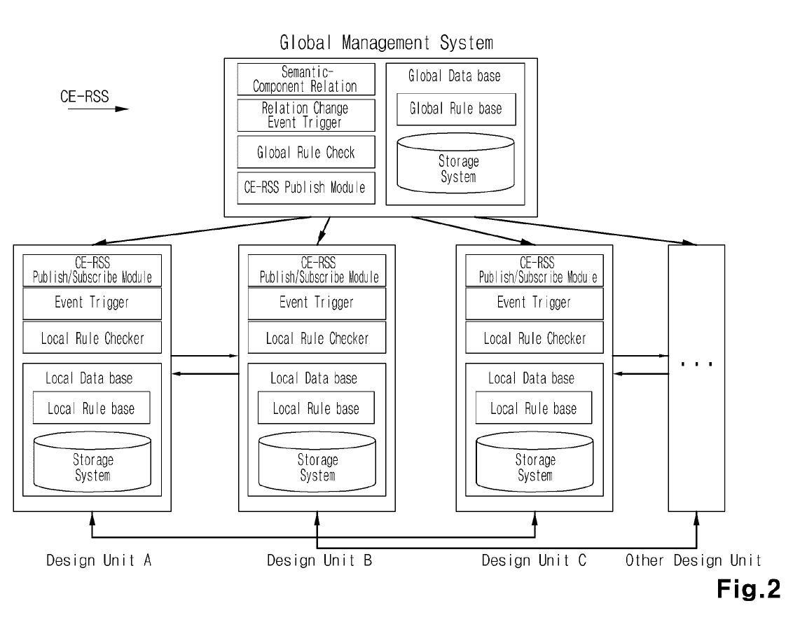

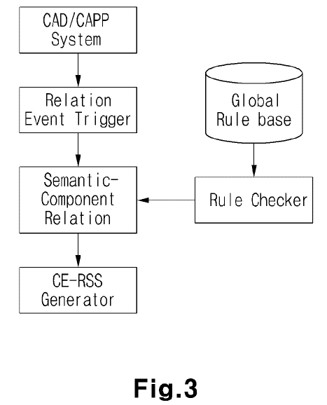

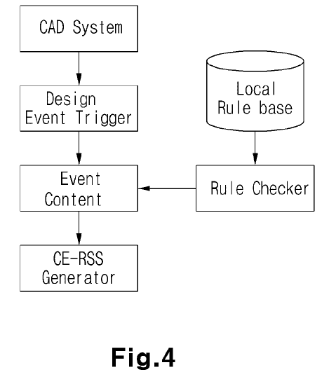

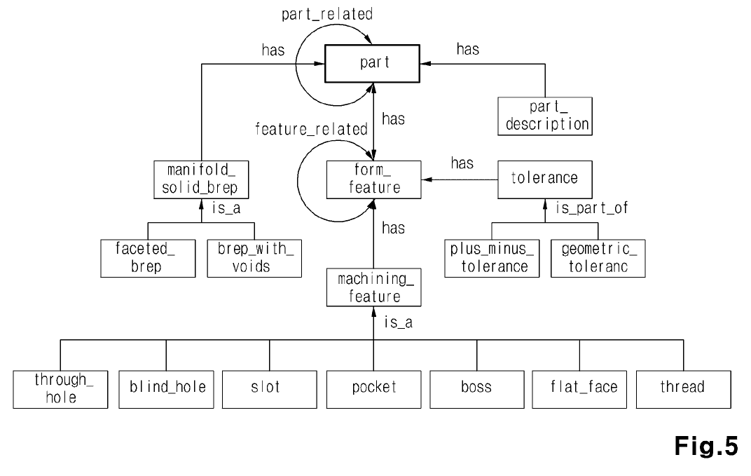

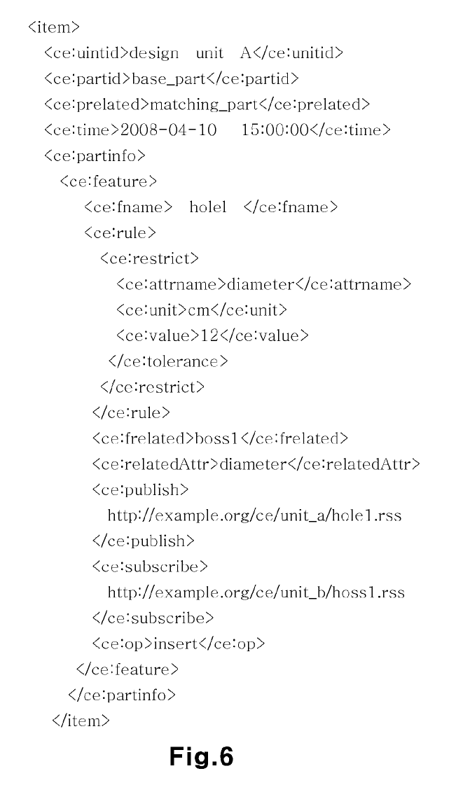

FIG. 1 is a flowchart illustrating a method of representing a subscribe relation in a design process using an interrelation between components according to an embodiment of the present invention. FIG. 2 is a diagram illustrating a global management system (GMS), a structure of each design unit, and a data flow between the GMS and each design unit. FIG. 3 is a diagram illustrating a work flow process in the GMS in FIG. 2. FIG. 4 is a diagram illustrating a work flow process in the design unit in FIG. 2. FIG. 5 is a diagram illustrating an interrelation between components of a design product according to an embodiment of the present invention. FIG. 6 is a diagram illustrating a RSS feed for determining a subscribe relation between design units using a concurrent engineering RSS (CE-RSS) tag transmitted from a GMS to the design unit according to an embodiment of the present invention.

FIG. 1 is a flowchart illustrating a method of representing a subscribe relation in a design process using an interrelation between components according to an embodiment of the present invention.

Referring to FIG. 1, the method of representing a subscribe relation in a design process using an interrelation between components includes a first step S10 of establishing a resource description framework (RDF) site summary (or really simple syndication; RSS) subscribe relation between multiple design units dependent on each other in a design process using relation between product components, a second step S20 of triggering a design modification event occurring in the design process of each component of a final product, to convert update information by the design modification event into an extended RSS subscribe format, and a third step S30 of transmitting the extended RSS subscribe format to a corresponding design unit affected by the design modification.

In this case, the second step S20 includes triggering the relation change between the components according to a change of the product structure to deliver the change-related relation information to a semantic-component relation module, checking the reasonableness of the semantic-component relation module, and converting the relation information into a component relation update information summary. That is, the second step S20 performs the above processes through a global management system (GMS), which will be described in detail with reference to FIG. 2. Also, specific procedures of the method of representing a subscribe relation in a design process using the relation between components according to an embodiment of the present invention will be described in detail with reference to FIGS. 2 through 6.

FIG. 2 is a diagram illustrating a global management system (GMS), a structure of each design unit, and a data flow between the GMS and each design unit.

Referring to FIG. 2, according to an embodiment of the present invention, RDF information representing the relation information between product components is included. Based on the RDF information, a method of regulating RSS publish and subscribe relation between component design units is provided. Also, a method of allowing the GMS and each design unit to subscribe and apply the update information RSS to the design process, and an extended CE-RES tag specification for a cooperative design are provided.

1. Configuration of Global Management System (GMS) and Each Design Unit, and Data Flow

The GMS includes a semantic-component relation module, a relation change event trigger module, a global rule check module, a CE-RSS publish module, and a global database.

In this case, the global database includes a storage system for storing general data related to a product, and a global rule base.

The semantic-component relation module represents the relation between product components with the RDF, to thereby facilitate the retrieval of related components from given components and the understanding of the relation between the components. According to an embodiment of the present invention, modification of the component relation, the design structure and values in the product design process is considered as an event.

The relation change event trigger module triggers a corresponding modification event when the configuration of the product components or the relation between the product components is modified in the overall planning process or design process.

The global rule check module performs a rule check in consideration of the overall product design process upon failure of its own local rule check when the relation between the components changes or when each design unit receives update information of component information from other related component design unit.

When an event such as overall product component information update and a change of the relation between the product components occurs, the CE-RSS publish module converts information on the corresponding event triggered by the relation change event trigger module into information of a CE-RSS format and publishes the information of the CE-RSS format. The GMS includes and manages general product-related information over all design units of concurrent engineering process in a distributed environment, and includes relations between product components constituting a final product. The latest update information on the components of the final product and the relation therebetween are in real-time published to a corresponding design unit in the CE-RSS format. The general flow between the GMS and each design unit has been described in FIG. 2.

FIG. 3 is a diagram illustrating a work flow process in the GMS in FIG. 2.

Referring to FIG. 3, the GMS manages each component of the product, while overall planning and design processes are performed by a CAD/CAPP system. If the relation between the product components changes due to a change of the product structure, the relation event trigger module triggers the change to deliver a corresponding information to the semantic-component relation module. A rule checker checks the reasonableness of a new semantic-component relation module based on the global rule base. If the rule check is passed, the corresponding relation information is converted into a component relation update information summary through a CE-RSS generator, and exposed to each related design unit in the RSS format.

FIG. 4 is a diagram illustrating a work flow process in the design unit in FIG. 2.

Referring to FIG. 4, the work process flow in the design unit according to an embodiment of the present invention is shown. First, each design unit performs a design work using a CAD system. Update information on changes of component structure and specification in the design process is triggered by the event trigger module when the CAD system delivers the corresponding design. The event trigger module compares differences between new information and previous information to generate event contents. The rule checker receives the corresponding rule from the local rule base to check the reasonableness of the generated event contents. Thus, after the rule check, the event contents is converted into a design update information summary through a CE-RSS generator, and exposed to a related design unit in the RSS format.

In an initial step of concurrent design, each design unit receives design component information and various local rules, which the design unit must comply with in the design process, from the GMS using an identifier. The component information includes a CE-RSS publish specification with respect to each structure having a relation with other components besides information on the design specification. The component information and local rule may obtain current values from the GMS through web service whenever necessary. That is, the design unit may actively obtain the current values from the GMS. After the assignment of the initial information is completed, the GMS publishes a related CE-RSS whenever the relation between the product components is updated. Each design unit obtains the updated component relation information to update the relations with other design units by using a CE-RSS publish/subscribe module. The event generated in the design unit during the component design process is captured by a self-event trigger to be converted into the CE-RSS format through the CE-RSS publish module. Then, the information of the CE-RSS format is delivered to a design unit subscribing a CE-RSS of the corresponding design unit. A local rule check module determines an action to be processed, using the CE-RSS information of the related design unit collected through the CE-RSS feed module. If the result value of the local rule check is misty, the corresponding event information is delivered to the GMS so that the GMS may mediate modification of the component information.

2. Product Component Relation Model

FIG. 5 is a diagram illustrating an interrelation between components of a design product according to an embodiment of the present invention.

Referring to FIG. 5, in the GMS, the relation model between the product components may be represented as CF, CR, and FR. In this case, C represents a class set abstracting the product components, F represents the structure features of the product component, CR refers to class relation set, and FR refers to feature relation set of the product components. The relation between the classes has a property such as {has, is_part_of, part_related, feature_related}, where “has” is transitive, and refers to ownership, “is_part_of” is transitive, and refers to inclusion, “part_related” is symmetry, and refers to a relation between components, and “feature_related is symmetry, and refers to a relation between component forms. In this case, “transitive” means that the corresponding relation is delivered to a derived class, and “symmetry” means that an interaction between classes is symmetrically performed. Based on such a model, a relation between product components according to an embodiment of the present invention has been described in FIG. 4. As described in FIG. 4, a part indicates a product component, and it is shown that one part and the other part have a part_related relation therebetween. The part has a form_feature, i.e., a structure characteristic, and has a relation. In this case, the form_feature also has a feature_related relation with other form_features. Since the has relation is transitive, all subordinate classes of the part and the form_feature has the has relation with the superordinate class. In FIG. 4, other elements refer to engineering-related elements to be used in embodiments of the present invention. The GMS infers from the above relations, determines the relation between product components, and further determines the relations between the design units designing the corresponding components. Every modification of overall product structure causes the change of the relation, which is triggered the relation change event trigger of the GMS. Then, the relation change is described in the semantic component relation module using the relation terms as described above.

3. CE-RSS (Concurrent Engineering RSS) Tag for Design Process Event Transmission

The CE-RSS includes an update information representation tag delivered from the GMS to each design unit when the relation between product components changes, and an update information representation tag delivered to the corresponding component-related component design unit when there is a change in the component design process. The descriptions of the tags are identical to those of the CE-RSS tags listed in the following Table 1.

TABLE 1

| Tag | Necessity | Description |
|---|---|---|
| ce:unitid | Necessary | Design unit ID |
| ce:partid | Necessary | Design component ID |
| ce:feature | Necessary | Each form ID of design component |
| ce:time | Necessary | Update information generation time |
| ce:partInfor | Optional | May include detailed component |
| | | information on demand according to |
| | | component information, complex type |
| ce:rule | Optional | May include rule to be checked for |
| | | component design change, restriction |
| | | ce:restrict necessary for rule representation |
| | | in complex type, attribute name |
| | | ce:attrname, attribute representation |
| | | unit ce:unit, ce:value. |
| ce:prelated | Necessary | Component ID dependent on design |
| | | component |
| ce:frelated | Optional | Form ID of other component dependent on |
| | | one form of design component |
| ce:relatedAttr | Optional | Attribute name of other dependent |
| | | component form |
| ce:publish | Optional | URL recommended for distribution of |
| | | CE-RSS |
| ce:subscribe | Optional | Update information CE-RSS URL of form or |
| | | component distributed in other dependent |
| | | design unit |
| ce:op | Optional | Update action of form information or |
| | | component information, for example, insert, |
| | | delete, update, etc. |

FIG. 6 is a diagram illustrating a RSS feed for determining a subscribe relation between design units using a CE-RSS tag transmitted from a GMS to the design unit according to an embodiment of the present invention.

Referring to FIG. 6, in the RSS feed for determining a subscribe relation between design units using a CE-RSS tag transmitted from a GMS to the design unit, each design unit requests component information from the GMS through its own identifier. The GMS confirms components that each design unit designs, and a relation between component structures using the identifier and the semantic-component relation module. Such a relation is delivered to each design unit through ce:publish and ce:subscribe tags.

Accordingly, a method of representing a feed relation in a design process using a relation between component according to the embodiment of the present invention can reduce a burden such as a message transmission of an event generator and a confirmation of a message receipt, by adding and extending tags necessary for a cooperative design in a concurrent engineering environment to a RSS specification, which is widely used, to represent and publish various event information triggered in the design process as the extended CE-RSS, and by confirming the event information not through a message transmission actively performed by the event generator but through a subscription of the design unit having a dependency relation in the design. Also, based on XML, easy data parsing, and RSS standards, the corresponding message can be subscribed in a general RSS reader. Accordingly, since developments of a separate message protocol and a decoding application are not required, the cost of development can be saved. Moreover, the method can reduce data transmission traffic and message filtering workload, and prevent an information exposure to an undesired party, by not accepting all event information occurring in each design unit during the concurrent engineering design process, but establishing a subscribe relation using the relation between the components and confirming event information related to its own design when necessary.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of representing a subscribe relation in a design process using a relation between components, the method comprising:
Establishing a resource description framework (RDF) site summary (or really simple syndication; RSS) subscribe relation between multiple design units dependent on each other in a design process using relation between product components;
triggering, by the multiple design units, an event occurring in the design process of each component of a final product, to convert update information by the design modification event into an extended RSS subscribe format; and
transmitting the extended RSS subscribe format to a corresponding design unit affected by the design modification.

2. The method of claim 1, wherein the triggering of the event comprises:
triggering the relation change between the components according to a change of the product structure to deliver the change-related relation information to a semantic-component relation module;
checking the reasonableness of the semantic-component relation module; and
converting the relation information into a component relation update information summary.

3. The method of claim 1, wherein the event is one of a component relation change, a design structure change, and a numerical value change.

4. The method of claim 1, wherein the transmitting of the extended RSS subscribe format comprises a concurrent engineering RSS (CE-RSS) tag.

5. The method of claim 4, wherein the CE-RSS tag comprises:
an update information representation tag delivered to each design unit when the relation between product components changes; and
an update information representation tag delivered to a corresponding component-related component design unit when there is a change in a component design process.
